(19) United States
(12) Patent Application Publication
(10) Pub. No.: US 2018/0115757 A1
(43) Pub. Date: Apr. 26, 2018

(54) MESH-BASED AUTO WHITE BALANCING

(71) Applicant: QUALCOMM Incorporated, San Diego, CA (US)

(72) Inventors: Shang-Chih Chuang, New Taipei (TW); Wei-Chih Liu, Taipei (TW); Kyuseo Han, San Diego, CA (US)

(21) Appl. No.: 15/331,511

(22) Filed: Oct. 21, 2016

(51) Int. Cl. H04N 9/73; H04N 9/07

(52) U.S. Cl. CPC H04N 9/735; H04N 9/07

(57) ABSTRACT

In one example, a method for white balancing image data includes obtaining, for a zone of a color space, a mesh defining a plurality of polygons having vertices that are each associated with one or more white balance parameters; identifying a polygon of the plurality of polygons that includes a pixel of the image data; determining one or more white balance parameters for the pixel of the image data based on an interpolation of white balance parameters associated with vertices of the polygon that includes the pixel of the image data; and performing, based on the one or more white balance parameters for the pixel of the image data, a white balance operation on the pixel of the image data.

### TECHNICAL FIELD

This disclosure relates to white balancing of image data, and more particularly, to techniques for automatic white balancing of image data.

### BACKGROUND

Digital cameras are commonly incorporated into a wide variety of devices. In this disclosure, a digital camera device refers to any device that can capture one or more digital images, including devices that can capture still images and devices that can capture sequences of images to record video. By way of example, digital camera devices may comprise stand-alone digital cameras or digital video camcorders, camera-equipped wireless communication device handsets such as mobile telephones, cellular or satellite radio telephones, camera-equipped mobile phones, camera-equipped wearable devices, computer devices that include cameras such as so-called “web-cams,” or any devices with digital imaging or video capabilities.

In digital camera devices, calibration is often needed to achieve proper white balance. White balance (sometimes called color balance, gray balance or neutral balance) refers to the adjustment of relative amounts of primary colors (e.g., red, green and blue) in an image or display such that neutral colors are reproduced correctly. White balance may change the overall mixture of colors in an image. Without white balance, the display of captured images may contain undesirable tints.

### SUMMARY

In one example, method for white balancing image data includes obtaining, for a zone of a color space, a mesh defining a plurality of polygons having vertices that are each associated with one or more white balance parameters; identifying a polygon of the plurality of polygons that includes a pixel of the image data; determining one or more white balance parameters for the pixel of the image data based on an interpolation of white balance parameters associated with vertices of the polygon that includes the pixel of the image data; and performing, based on the one or more white balance parameters for the pixel of the image data, a white balance operation on the pixel of the image data.

In another example, a device for white balancing image data includes a memory configured to store the image data; and one or more processors. In this examples, the one or more processors are configured to: obtain, for a zone of a color space, a mesh defining a plurality of polygons having vertices that are each associated with one or more white balance parameters; identify a polygon of the plurality of polygons that includes a pixel of the image data; determine one or more white balance parameters for the pixel of the image data based on an interpolation of white balance parameters associated with vertices of the polygon that includes the pixel of the image data; and perform, based on the one or more white balance parameters for the pixel of the image data, a white balance operation on the pixel of the image data.

In another example, a device for white balancing image data includes means for obtaining, for a zone of a color space, a mesh defining a plurality of polygons having vertices that are each associated with one or more white balance parameters; means for identifying a polygon of the plurality of polygons that includes a pixel of the image data; means for determining one or more white balance parameters for the pixel of the image data based on an interpolation of white balance parameters associated with vertices of the polygon that includes the pixel of the image data; and means for performing, based on the one or more white balance parameters for the pixel of the image data, a white balance operation on the pixel of the image data.

In another example, a non-transitory computer-readable storage medium stores instructions that, when executed, cause a device for white balancing image data to: obtain, for a zone of a color space, a mesh defining a plurality of polygons having vertices that are each associated with one or more white balance parameters; identify a polygon of the plurality of polygons that includes a pixel of the image data; determine one or more white balance parameters for the pixel of the image data based on an interpolation of white balance parameters associated with vertices of the polygon that includes the pixel of the image data; and perform, based on the one or more white balance parameters for the pixel of the image data, a white balance operation on the pixel of the image data.

The details of one or more aspects are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an exemplary digital camera device capable of implementing white balance calibration techniques of this disclosure.

FIGS. 2A-2D are conceptual diagrams illustrating example gray zones that may be used by an AWB system, in accordance with one or more techniques of this disclosure.

FIGS. 3A-3C are conceptual diagrams illustrating example gray zones divided into polygons by triangulation, in accordance with one or more techniques of this disclosure.

FIG. 4 is a conceptual diagram illustrating an example black body locus curve used by an AWB system, in accordance with one or more techniques of this disclosure.

FIG. 5 is a conceptual diagram illustrating a pair of gray zone boundary points determined for reference point 32C, in accordance with one or more techniques of this disclosure.

FIG. 6 is a conceptual diagram illustrating an example interpolation that may be performed by an AWB module to determine one or more white balance parameters for a pixel of image data, in accordance with one or more techniques of this disclosure.

FIG. 7 is a conceptual diagram illustrating an example technique for identifying a triangle of a triangular matrix that includes a particular pixel of image data, in accordance with one or more techniques of this disclosure.

FIG. 8 is a conceptual diagram illustrating the addition of additional points into a mesh, in accordance with one or more techniques of this disclosure.

FIG. 9 is a block diagram illustrating a wireless communication device 48 capable of implementing the techniques of this disclosure.

FIG. 10 is a flow diagram illustrating example auto white balance operations using a mesh, in accordance with one or more techniques of the present disclosure.

### DETAILED DESCRIPTION

An auto white balance (AWB) system makes a scene match the perceptual feeling to human eyes, e.g., so that objects appearing gray for human eyes are corrected to gray in the photo. Gray objects captured by image sensors are often bluish in high color temperature scenes, and are reddish in lower color temperature ones. In practice, an AWB system may detect gray objects in a photo which might not have the same RGB values and apply balance gains to the whole image to make these objects appear gray.

Some AWB system may adjust photos based on a gray zone. Under different color temperature environments, the same gray objects may have the different RGB values. If the RGB value of an image pixel is located in a pre-defined gray zone, the image pixel is seen as a gray pixel under certain color temperatures, but may be bluish or reddish under other color temperatures. As such, an AWB system may aggregate pixels in a photo located in the gray zone and calculate R, G, and B gains to make these pixels appear gray.

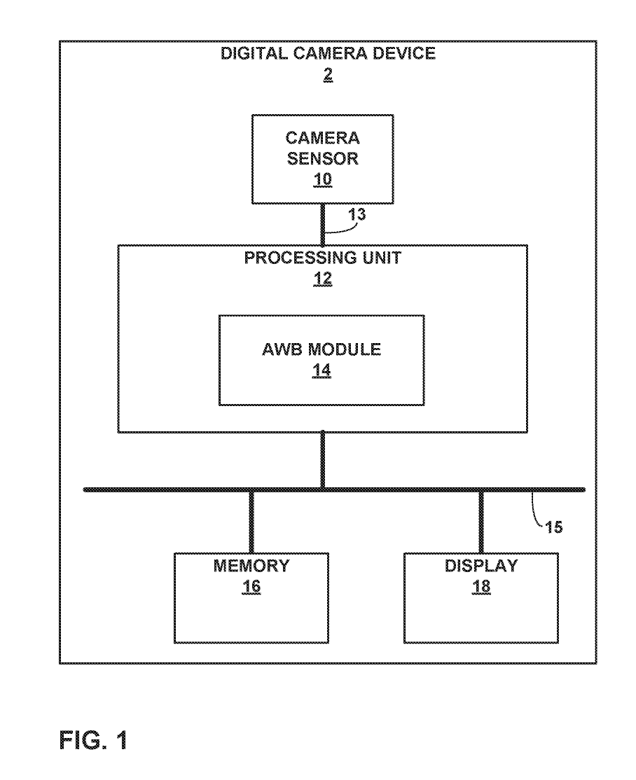

FIG. 1 is a block diagram illustrating an exemplary digital camera device 2 that implements techniques of this disclosure. By way of example, digital camera device 2 may comprise a stand-alone digital camera, a digital video camcorder, a camera-equipped wireless communication device handset, such a cellular or satellite radio telephone, a camera-equipped tablet computing device, a computer device equipped with a digital camera, web-cam or the like, or any other device with imaging or video capabilities. As shown in FIG. 1, digital camera device 2 includes camera sensor 10, processing unit 12, memory 16, and display 18. Display 18, memory 16, and processing unit 12 may be communicatively coupled to one another via a shared data communication bus 15.

In the example of FIG. 1, device 2 comprises a camera sensor 10 that captures information. The captured information may comprise output of camera sensor 10 that could be used to define one or more still image photographs, or image frames of a video sequence. The described calibration technique, however, may operate during a viewfinder mode in which the captured information is not presented as recorded images or recorded video. The captured information may be used in the calibration procedure without the knowledge of the user. The described techniques may occur every time camera sensor 10 is operating, e.g., any time information is being captured by camera sensor 10.

The captured information may be sent from camera sensor 10 to processing unit 12 via a dedicated bus 13. Processing unit 12 may be referred to as an imaging “front end,” and may comprise a unit or possibly a pipeline of units that perform various image processing functions. The functions performed by processing unit 12 may include scaling, white balance, cropping, demosaicing, signal noise reduction, sharpening or any other front end image data processing.

Camera sensor 10 may include a two-dimensional array of individual pixel sensor elements, e.g., arranged in rows and columns. In some aspects, each of the elements of camera sensor 10 may be associated with a single pixel. Alternatively, there may be more than one-pixel element associated with each pixel, e.g., each pixel may be defined by a set of red (R), green (G) and blue (B) pixel elements of camera sensor 10. Camera sensor 10 may comprise, for example, an array of solid state elements such as complementary metal-oxide semiconductor (CMOS) elements, charge coupled device (CCD) elements, or any other elements used to form a camera sensor in digital camera applications. Although not shown in FIG. 1, digital camera device 2 may include other optical components, such as one or more lenses, lens actuators for focal adjustment, shutters, a flash device to illuminate an image scene, and other components, if desired. The architecture illustrated in FIG. 1 is merely exemplary, as the techniques described in this disclosure may be implemented with a variety of other architectures.

Camera sensor 10 exposes its elements to the image scene, e.g., upon activation of a camera mode in digital camera device 2 by a user. Upon activation of camera mode, camera sensor 10 may, for example, capture intensity values representing the intensity of the captured light at each particular pixel position. In some cases, each of the elements of camera sensor 10 may only be sensitive to one color or one color band, due to color filters covering the sensors. For example, camera sensor 10 may comprise an array of elements with appropriate filters so as to define R, G and B channels. However, camera sensor 10 may utilize other types of color filters. Each of the elements of camera sensor 10 may capture intensity values for only one color. The captured information may include pixel intensity and/or color values captured by the elements of camera sensor 10. A given pixel may be defined by a set of R, G and B values.

Processing unit 12 receives raw data (i.e., captured information) from camera 10, and may perform any of a wide variety of image processing techniques on such raw data. As mentioned above, processing unit 12 may comprise a processing pipeline, or possibly several different units that perform different processing functions. The captured and processed image data is stored in memory 16, and possibly displayed to a user via display 18.

As illustrated in FIG. 1, processing unit 12 may include auto-white balance (AWB) module 14, which may perform a white balance operation on one or more pixels of image data, such as one or more pixels of image data captured by camera sensor 10. For instance, AWB module 14 may perform the white balance operation based on one or more white balance parameters for pixels of the image data. Some white balance parameters include, but are not necessarily limited to, a color correction matrix (CCM), a color temperature (CT), and an aggregation weight (AW). As discussed in further detail below, and in accordance with one or more techniques of this disclosure, AWB module 14 may use a mesh-based approach to perform white balancing.

Memory 16 may comprise any form of volatile or non-volatile memory, such as read-only memory (ROM), a form of random access memory (RAM), electrically erasable programmable read-only memory (EEPROM), FLASH memory, or some type of data storage drive or unit. Typically, memory 16 may be implemented as some type of RAM or FLASH memory to ensure fast data transfer between the different components of device 2.

Display 18 may comprise a viewfinder for digital camera device 2, e.g., in order to provide the user with up-to-date images associated with the scene that is being captured by camera sensor 10. Captured images or video may also be presented on display 18 for viewing by a user.

Depending on the implementation, device 2 may also include many other components. For example, device 2 may include one or more image encoders, such as Joint Photographic Experts Group (JPEG) encoders to compress images, or one or more video encoder, such as Motion Pictures Expert Group (MPEG) encoders or International Telecommunication Union (ITU) H.263 or H.264 encoders to compress video. Also, if device 2 is implemented as a wireless communication device handset, device 2 may include various components for wireless communication, such as a wireless transmitter, wireless receiver, a modulator-demodulator (MODEM), and one or more antennas. These or other components may be included in device 2, depending upon implementation. These other components are not shown in FIG. 1 for simplicity and ease of illustration of the calibration techniques described herein.

AWB module 14 may be implemented as hardware comprising fixed function and/or programmable processing circuitry, software, firmware, or any of a wide variety of combinations of hardware, software or firmware. AWB module 14 may be realized by one or more microprocessors, digital signal processors (DSPs), application specific integrated circuits (ASICs), field programmable gate arrays (FPGAs), or any other equivalent discrete or integrated logic circuitry, or a combination thereof. If implemented in software, instructions executed as part of the calibration process may be stored on a computer-readable medium and executed in one or more processors to realize the functionality of AWB module 14 and cause device 2 to perform the techniques described herein.

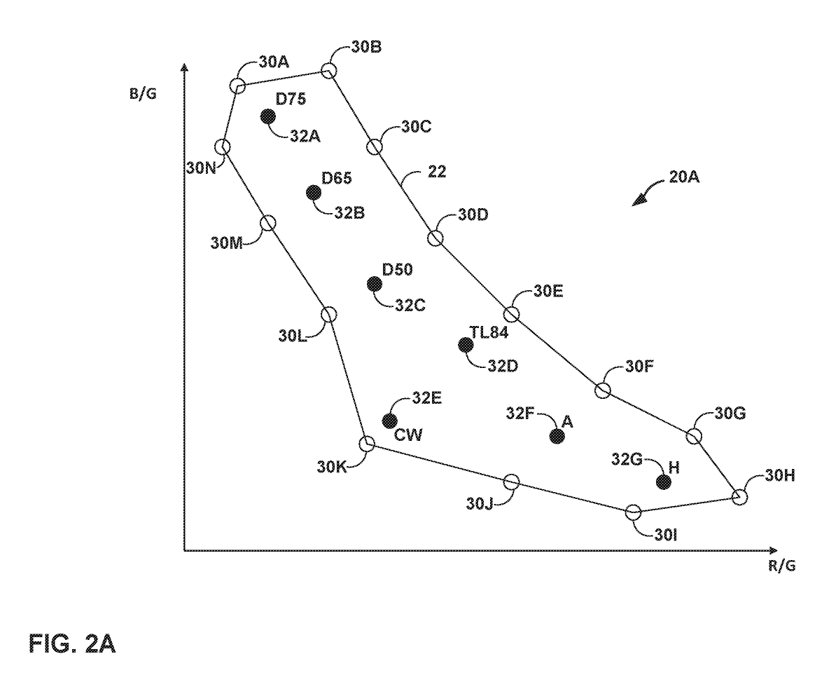

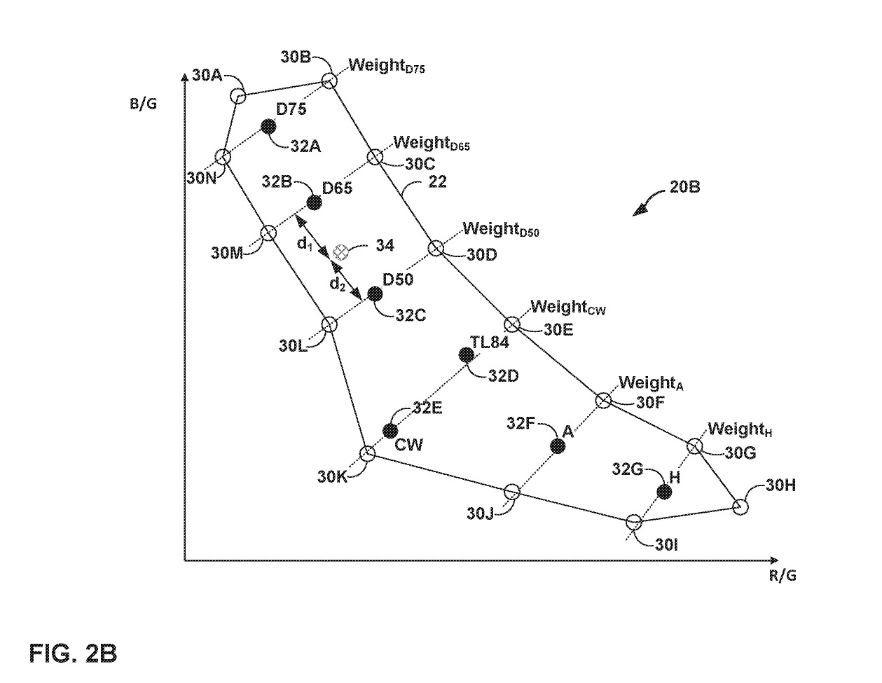

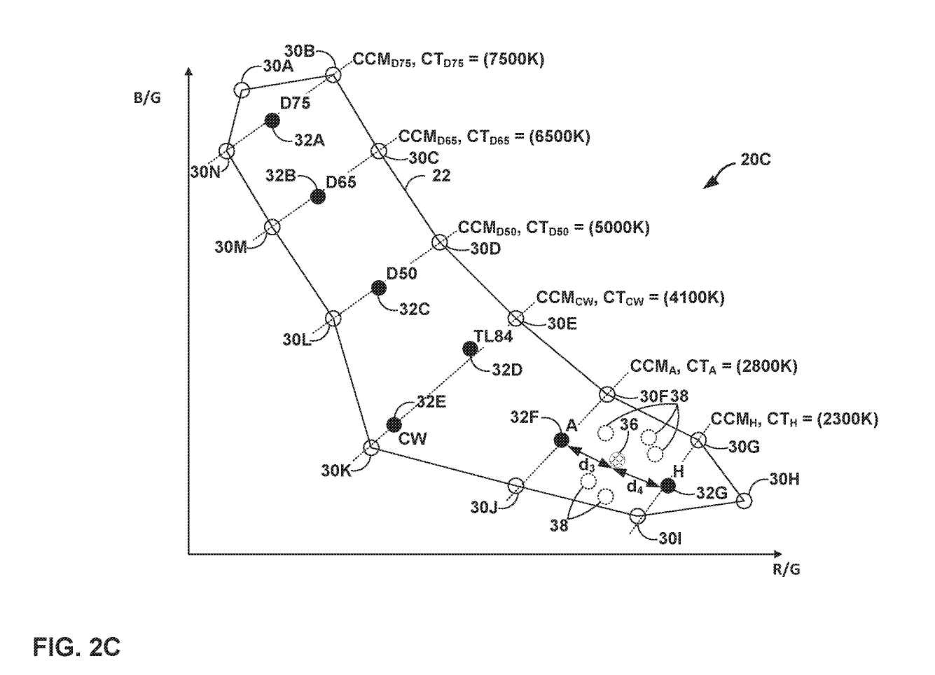

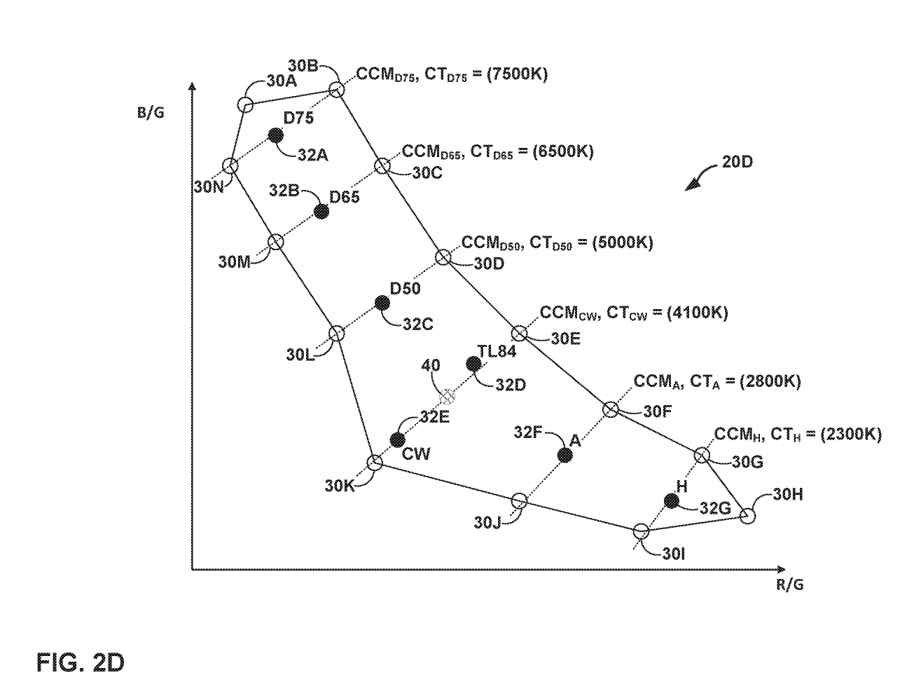

FIGS. 2A-2D are conceptual diagrams illustrating example gray zones that may be used by an AWB system, in accordance with one or more techniques of this disclosure. As illustrated in FIG. 2A-2D, gray zones 20A-20D (collectively, “gray zones 20”) may be defined on a red/green (R/G) and blue/green (B/G) color domain. Each of gray zones 20 may be bounded by boundary 22, which may be defined based on gray zone boundary points 30A-30N (collectively, “gray zone boundary points 30”). As discussed below, gray zone boundary points 30 may be defined according to reference points 32A-32G (collectively, “reference points 32”).

Reference points 32 may be calibrated under several standard illuminants. For instance, as shown in FIGS. 2A-2D, reference point 32A may be calibrated based on standard illuminant D75. Similarly, reference points 32B, 32C, 32D, 32E, 32F, and 32G may be respectively calibrated based on standard illuminants D65, D50, TL84, CW, A, and H. Each of reference points 32 may be associated with pre-defined values for one or more white balance parameters. For instance, each of reference points 32 may be associated with a pre-defined aggregation weight (AW), a pre-defined color correction matrix (CCM), and a pre-defined color temperature (CT).

Gray zone boundary points 30 may be defined according to reference points 32 and boundary distances. As discussed in further detail below, each of reference points 32 may be associated with a pair of gray zone boundary points of gray zone boundary points 30. Additionally, one or more of reference points 32 may be associated with a third gray zone boundary point of gray zone boundary points 30. For instance, each of reference points 32A and 32G may be associated with three gray zone boundary points of gray zone boundary points 30.

When a pixel is located in gray zone 20 between calibrated reference points, an AWB module, such as AWB module 14, may calculate one or more white balance parameters (e.g., AW, CCM, and CT) for the pixel by interpolating white balance parameters of the calibrated reference points in a single dimension. For instance, in the example of FIG. 2B where sample pixel 34 is located between reference points 32B and 32C (corresponding to illuminants D65 and D50), AWB module 14 may interpolate the AW of sample pixel 34 based on a pre-defined AW for reference point 32B (i.e., Weight_{D65}) and a pre-defined AW for reference point 32C (i.e., Weight_{D50}). As one example, AWB module 14 may calculate the AW of sample pixel 34 in accordance with Equation (1), below, where weight is the AW of sample pixel 34, d₁ is the distance between sample pixel 34 and a line connecting gray zone boundary points 30C and 30M, and d₂ is the distance between sample pixel 34 and a line connecting gray zone boundary points 30D and 30L. In some examples, such as where a sample pixel is located outside of gray zone boundary 22, AWB module 14 may determine that the values for one or more white balance parameters for the pixel are zero.

$$weight = \frac{{Weight}_{D 65} \times {d}_{2} + {Weight}_{D 50} \times {d}_{1}}{{d}_{2} + {d}_{1}} \qquad ( 1 )$$

To calculate a balance gain pair for an image, AWB module 14 may aggregate the determined aggregation weights for each pixel in the image. In some examples, for an N×M image, AWB module 14 may aggregate the determined aggregation weights in accordance with Equations (2) below, where R,/B,/G, are the R/B/G values of pixel i, weight, is the determined AW for pixel i, Rₛᵤₘ/Bₛᵤₘ/Gₛᵤₘ are the respective aggregated weights for red/blue/green values.

$${R}_{sum} = {\sum }_{N \times M}^{ } {R}_{i} \times {weight}_{i} \\ {B}_{sum} = {\sum }_{N \times M}^{ } {B}_{i} \times {weight}_{i} \\ {G}_{sum} = {\sum }_{N \times M}^{ } {G}_{i} \times {weight}_{i} \qquad ( 2 )$$

AWB module 14 may then calculate the balance gain pair for the image based on the aggregated weights. For instance, AWB module 14 may calculate the balance gain pair for the image in accordance with Equations (3), below, where Gain_{R} is the red component of the balance gain pair and Gain_{B} is the blue component of the balance gain pair.

Gain_{R}=Gₛᵤₘ/Rₛᵤₘ

Gain_{B}=Gₛᵤ/Bₛᵤₘ (3)

AWB module 14 may similarly determine other white balance parameters. For example, FIG. 2C illustrates a pre-defined color correction matrix (CCM) and color temperature (CT) for each of reference points 32. In the example of FIG. 2C, pixels 38 may be pixels located in gray zone 20C and sample pixel 36 may be a sample balance gain pair aggregated based on pixels 38. AWB module 14 may interpolate a color correction matrix (CCM) for sample pixel 36 based on a pre-defined CCM for reference point 32F (i.e., CCM_{A}) and a pre-defined CCM for reference point 32G (i.e., CCM_{H}). For instance, AWB module 14 may interpolate a CCM for sample pixel 36 in accordance with Equation (4), below, where CCM is the CCM of sample pixel 36, d₃ is the distance between sample pixel 36 and a line connecting gray zone boundary points 30F and 30J, and d₂ is the distance between sample pixel 36 and a line connecting gray zone boundary points 30G and 30I.

$$CCM = \frac{{CCM}_{A} \times {d}_{4} + {CCM}_{H} \times {d}_{3}}{{d}_{4} + {d}_{3}} \qquad ( 4 )$$

Similarly, AWB module 14 may interpolate a color temperature (CT) for sample pixel 36 based on a pre-defined CT for reference point 32F (i.e., CT_{A}) and a pre-defined CT for reference point 32G (i.e., CT_{H}). For instance, AWB module 14 may interpolate a CT for sample pixel 36 in accordance with Equation (5), below, where CT is the CT of sample pixel 36, d₃ is the distance between sample pixel 36 and a line connecting gray zone boundary points 30F and 30J, and d₂ is the distance between sample pixel 36 and a line connecting gray zone boundary points 30G and 30I.

$$CT = \frac{{CT}_{A} \times {d}_{4} + {CT}_{H} \times {d}_{3}}{{d}_{4} + {d}_{3}} \qquad ( 5 )$$

However, in some examples, the distribution of aggregation weight of a given pixel and CCM/CT for a given balance gain-pair may not be distributed linearly in color space. For example, the aggregation weight for sample pixel 34 of FIG. 2B located between reference points 32B and 32C might be mainly contributed by the pre-defined weight of reference points 32C, even the location of sample pixel 34 near the center of reference points 32B and 32C. As another example, the CCM and CT of sample pixel 36 of FIG. 2C located between reference points 32F and 32G might be much closer to the pre-defined CCM and CT for reference point 32F (i.e., in the real world).

FIG. 2D illustrates another example where sample pixel 40 is located between reference points 32D and 32E (e.g., between reference points for standard illuminations CW and TL84). In the example of FIG. 2D, it is not possible for AWB module 14 to interpolate the balance gain pair for sample pixel 40 because reference points 32D and 32E are orthogonal to 1-D segmentation. Additionally, in the example of FIG. 2D, tuning a parameter of a reference point may impact a large-scope AWB output.

As such, in the examples of FIGS. 2A-2D, AWB module 14 may define a gray zone and aggregates statistics in the zone to calculate balance gains, color correction matrix, color temperature as outputs. AWB module 14 may segment the gray zone into 1-D regions and determine AWB outputs by 1-D interpolation based on the distances to neighboring reference points. Since in this case, the AWB system decision is not linearly distributed in color space, it may be difficult to control the weighting of reference points and determine how to interpolate when the two reference points are orthogonal to 1-D segmentation.

In accordance with one or more techniques of this disclosure, AWB module 14 may use a mesh-based approach to perform white balancing. For instance, since the reference points are not linearly distributed and are variably located in a 2-D color space, e.g., R/G and B/G domain or UV domain, the gray zone may be considered as a mesh and divided into polygons. In this way, AWB module 14 may enable more accurate control of the white balancing process.

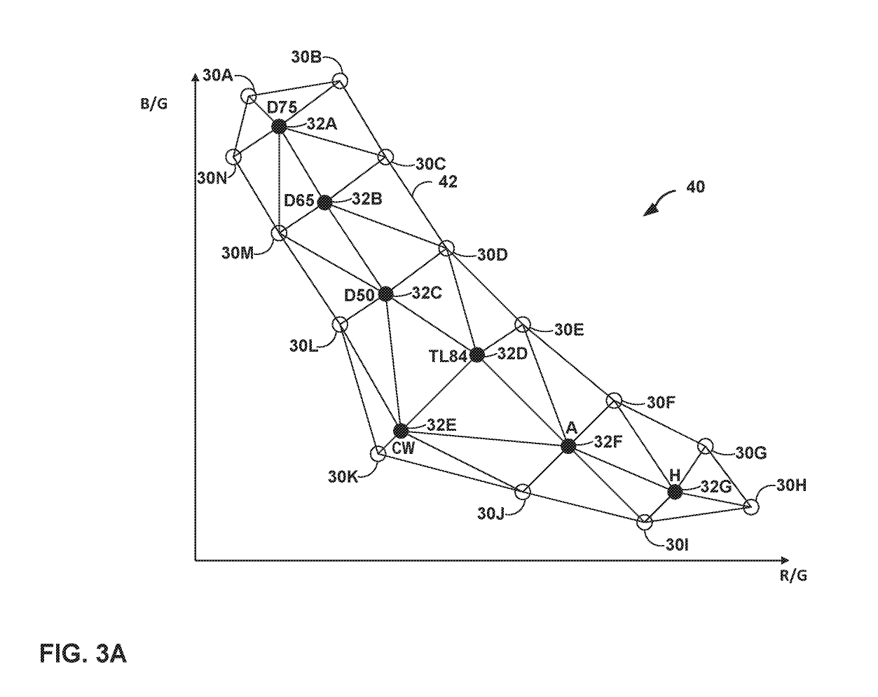

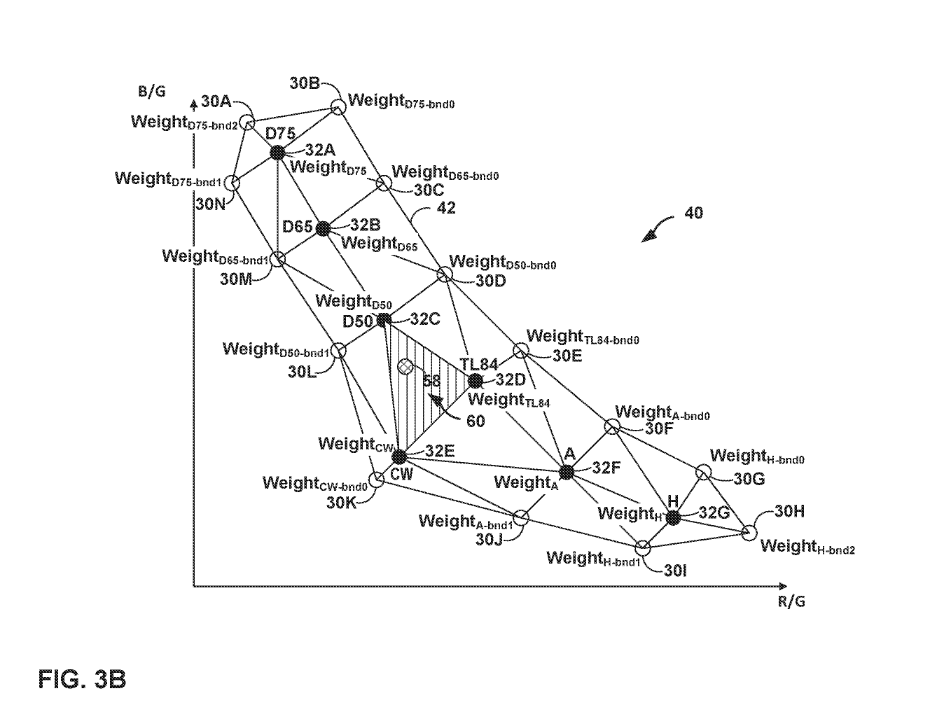

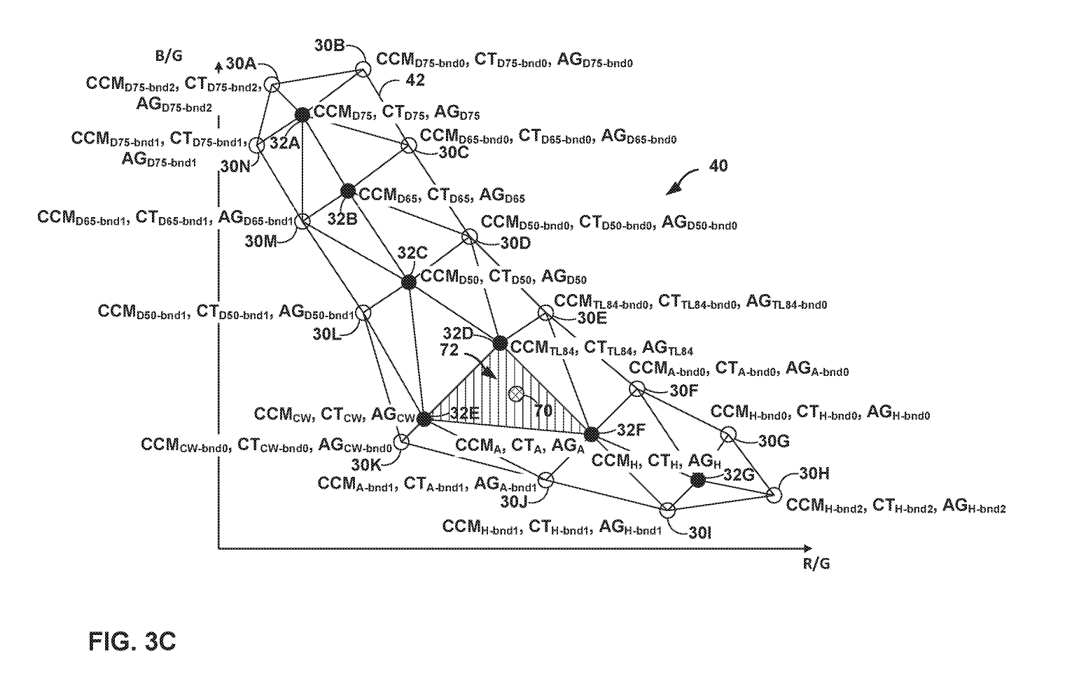

FIGS. 3A-3C are conceptual diagrams illustrating example gray zones divided into polygons by triangulation, in accordance with one or more techniques of this disclosure. Similar to gray zones 20 of FIGS. 2A-2D, gray zones 40 of FIGS. 3A-3C may be defined on a red/green (R/G) and blue/green (B/G) color domain. Gray zones 40 may be bounded by boundary 42, which may be defined based on gray zone boundary points 30.

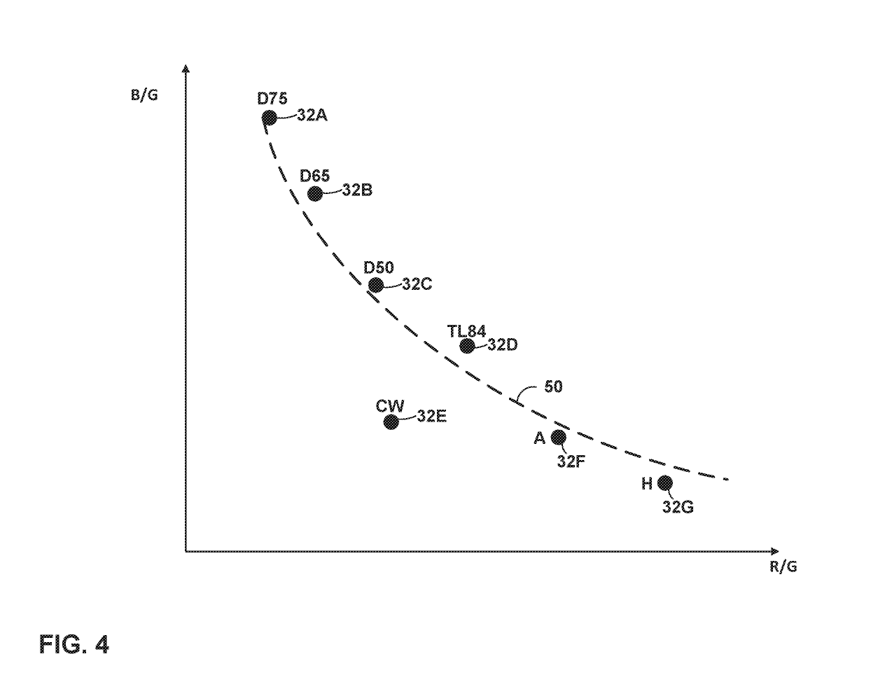

AWB module 14 may automatically generate gray zone boundary points 30 based on reference points 32 and a set of configurable gray zone distances. In some examples, AWB module 14 may estimate a black body locus curve, such as black body locus curve 50 of the example of FIG. 4, by a n^{th}-order polynomial fit with given reference points. For instance, AWB module 14 may estimate the black body locus curve in accordance with Equation (6), below, where x is R/G value of a reference point of reference points 32.

$$f ( x ) = {\sum }_{i = 0}^{n} {a}_{i} {x}^{i} , \qquad ( 6 )$$

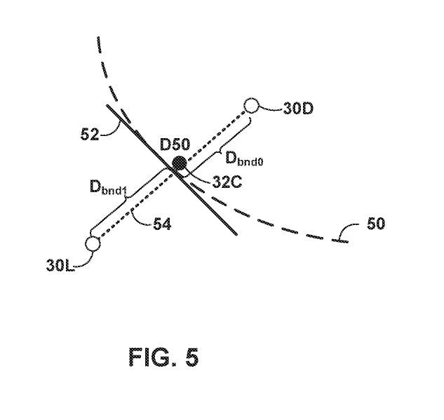

As discussed above, each reference point of reference points 32 may have a pair of corresponding gray zone boundary points of gray zone boundary points 30. FIG. 5 is a conceptual diagram illustrating a pair of gray zone boundary points determined for reference point 32C (e.g., corresponding to standard illumination D50), in accordance with one or more techniques of this disclosure. In some examples, AWB module 14 may perform automatic boundary point generation. For instance, to determine a pair of gray zone boundary points for a given reference point, AWB module 14 may compute a tangent line lₜ of the n^{th}-order polynomial equation f(x) at the given reference point and search the two corresponding gray zone boundary points that are located on a perpendicular line lₚ to the computed tangent line. The gray zone distances, D_{bnd0} and D_{bnd1}, determine the position of two gray zone boundary points, D50-bnd0 and D50-bnd1, on the perpendicular line, lₚ, respectively. For instance, in the example of FIG. 5, AWB module 14 may compute tangent line 52 of the n^{th}-order polynomial equation f(x) at reference point 32C, identify perpendicular line 54 to tangent line 52, and identify gray zone boundary points 30D and 30L along perpendicular line 54 based on gray zone distances, D_{bnd0} and D_{bnd1}.

In some examples, the gray zone distances can be different for each reference point. In addition, as discussed above, AWB module 14 may determine three gray zone boundary points for each of reference points 32A and 32G (corresponding to standard illuminations D75 and H). The third gray zone boundary point for reference points 32A and 32G may be located on the estimated black body locus curve, f(x) (e.g., black body locus curve 50 of FIG. 4), and have respective gray zone distances from reference points 32A and 32G.

By enabling AWB module 14 to automatically generate boundary 42 of gray zone 40, the techniques of this disclosure may provide an intuitive and efficient way to tune the distance between boundary points and reference ones for each reference point rather than settings constant outlier distance. As such, the resulting determined boundary of the gray zone may be more accurate.

In computational geometry, triangulation is a technique to divide a space into multiple triangles and form a mesh. Delaunay triangulation is one such technique. Delaunay triangulation has several favorable geometric properties since it is designed to maximize the minimum angles of all triangles in the mesh. For a set of points in 2-D space, the Delaunay triangulation of these points ensures the circumcircle associated with each triangle contains no other point in its interior. Some fast point location algorithms without infinite search loop are developed based on the properties.

As discussed above, AWB module 14 may use a mesh-based approach to perform white balancing. In accordance with one or more techniques of this disclosure, AWB module 14 may obtain, for a zone of a color space, a mesh defining a plurality of polygons. In some examples, the plurality of polygons may have vertices at reference points within the gray zone and/or at boundary points of the gray zone. For instance, AWB module 14 may perform triangulation to obtain a triangular mesh defining a plurality of triangles having vertices at reference points within the gray zone and/or at boundary points of the gray zone. In some examples, AWB module 14 may perform Delaunay triangulation to obtain the triangular mesh.

Compared with separating the gray zone into 1-D segments as discussed above, each point (e.g., each of reference points 32 and gray zone boundary points 30) may be associated with one or more white balance parameters, such as aggregation weight, color correction matrix (CCM), color temperature (CT), etc. As shown in the example of FIG. 3B, each of reference points 32 and gray zone boundary points 30 may be associated with a respective aggregation weight. Similarly, as shown in the example of FIG. 3C, each of reference points 32 and gray zone boundary points 30 may be associated with a respective CCM and a respective CT.

As discussed above, AWB module 14 may determine one or more white balance parameters for pixels of image data. In accordance with one or more techniques of this disclosure, AWB module 14 may identify a triangle of a triangular mesh that includes a pixel of the image data and determine one or more white balance parameters for the pixel of image data based on an interpolation of white balance parameters associated with vertices of the identified triangle. For instance, in the example of FIG. 3B, AWB module 14 may determine that sample pixel 58 is included in triangle 60, which has vertices at reference points 32C, 32D, and 32E (e.g., corresponding to standard illuminations D50, CW, and TL84). AWB module 14 may determine the one or more white balance parameters for sample pixel 58 by interpolating white balance parameters associated with reference points 32C, 32D, and 32E (i.e., the vertices of triangle 60 that includes sample pixel 58). In some examples, AWB module 14 may perform a Barycentric interpolation to determine the one or more white balance parameters. For instance, AWB module 14 may determine an aggregation weight (AW) for sample pixel 58 by performing a Barycentric interpolation of the AWs associated with reference points 32C, 32D, and 32E.

As the white balance parameters are calculated using a mesh-based interpolation, the AWB outputs may be smoothly transitioned when scenes change. Similarly, if the configuration of a point (i.e., a reference point or a gray zone boundary point) is hugely changed, the transition would still be stable. In this way, AWB module 14 may enable more accurate control of the white balancing process.

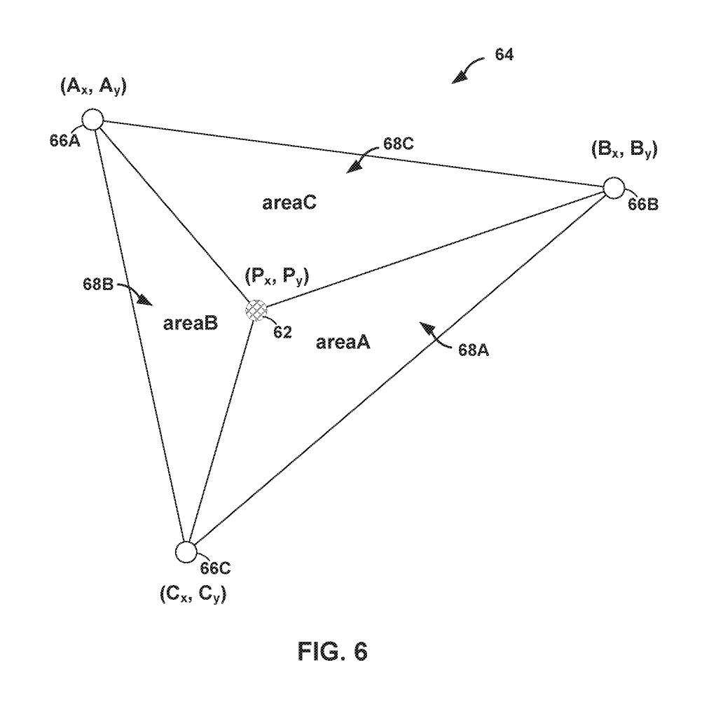

FIG. 6 is a conceptual diagram illustrating an example interpolation that may be performed by an AWB module to determine one or more white balance parameters for a pixel of image data, in accordance with one or more techniques of this disclosure. As discussed above, in some examples, AWB module 14 may perform a Barycentric interpolation to determine the one or more white balance parameters. For instance, as shown in the example of FIG. 6, sample pixel 62 may be included in triangle 64, which has vertices at points 66A-66C (collectively, “points 66”). As also shown in FIG. 6, triangle 64 may be divided into three sub-triangles 68A-68C (collectively, “sub-triangles 68”), each having a vertex at sample pixel 62 and vertices at two of points 66. Each of sub-triangles 68 may have an area, shown in FIG. 6

To perform the Barycentric interpolation, AWB module 14 may determine an area of each of sub-triangles 68. For instance, AWB module 14 may determine the area of each of sub-triangles 68 in accordance with Equations (7), below, where Aₓ, A_{y} are the x-y coordinates of point 66A, B, B_{y} are the x-y coordinates of point 66B, Cₓ, C_{y} are the x-y coordinates of point 66C, and Pₓ, P_{y} are the x-y coordinates of sample pixel 62

$$areaA = \vert \frac{{P}_{x} ( {B}_{y} - {C}_{y} ) + {B}_{x} ( {C}_{y} - {P}_{y} ) + {C}_{x} ( {P}_{y} - {B}_{y} )}{2} \vert , \\ areaB = \vert \frac{{A}_{x} ( {P}_{y} - {C}_{y} ) + {P}_{x} ( {C}_{y} - {A}_{y} ) + {C}_{x} ( {A}_{y} - {P}_{y} )}{2} \vert , and \\ areaC = \vert \frac{{A}_{x} ( {B}_{y} - {P}_{y} ) + {B}_{x} ( {P}_{y} - {A}_{y} ) + {P}_{x} ( {A}_{y} - {B}_{y} )}{2} \vert \qquad ( 7 )$$

AWB module 14 may determine a value for a white balance parameter of sample pixel 62 based on the determined areas and values of the white balance parameter for points 66. For instance, AWB module 14 may determine a value for a white balance parameter of sample pixel 62 in accordance with Equation (8), below, where Pᵥₐₗᵤₑ is the value for the white balance parameter determined for sample pixel 62, Aᵥₐₗᵤₑ is a pre-determined value for the white balance parameter for point 66A, Bᵥₐₗᵤₑ is a pre-determined value for the white balance parameter for point 66B, and Cᵥₐₗᵤₑ is a pre-determined value for the white balance parameter for point 66C.

$${P}_{value} = \frac{{A}_{value} \times aeraA + {B}_{value} \times areaB + {C}_{value} \times areaC}{aeraA + aeraB + aeraC} \qquad ( 8 )$$

To further illustrate, as discussed above, AWB module 14 may determine an aggregation weight (AW) for sample pixel 58 of FIG. 3B by performing a Barycentric interpolation of the AWs associated with reference points 32C, 32D, and 32E. For instance, AWB module 14 may determine the AW for sample pixel 58 in accordance with Equation (9), below, where Weight_{D50} is the AW of sample point 32C, Weight_{CW} is the AW of sample point 32E, Weight_{TL84} is the AW of sample point 32D, area_{D50} is the area of a sub-triangle of triangle 60 having a vertex at sample pixel 58 and not having a vertex at sample point 32C, area_{CW} is the area of a sub-triangle of triangle 60 having a vertex at sample pixel 58 and not having a vertex at sample point 32E, and area_{TL84} is the area of a sub-triangle of triangle 60 having a vertex at sample pixel 58 and not having a vertex at sample point 32D.

$$weight = \frac{\begin{matrix}{Weight}_{D 50} \times {area}_{D 50} + {Weight}_{CW} \times {area}_{CW} + \\ {Weight}_{TL 84} \times {area}_{TL 84}\end{matrix}}{{area}_{D 50} + {area}_{CW} + {area}_{TL 84}} \qquad ( 9 )$$

AWB module 14 may determine AWs for each pixel included the N×M image data that includes sample pixel 58. In some examples, if a pixel of the image data is outside of gray zone boundary 42, AWB module 14 may determine the AW for that pixel as zero. AWB module 14 may then aggregate the determined AWs. For instance, AWB module 14 may aggregate the determined aggregation weights in accordance with Equations (10) below, where Rᵢ/Bᵢ/Gᵢ are the R/B/G values of pixel i, weightᵢ is the determined AW for pixel i, and Rₛᵤₘ/Bₛᵤₘ/Gₛᵤₘ are the respective aggregated weights for red/blue/green values.

$${R}_{sum} = {\sum }_{N \times M}^{ } {R}_{i} \times {weight}_{i} \\ {B}_{sum} = {\sum }_{N \times M}^{ } {B}_{i} \times {weight}_{i} \\ {G}_{sum} = {\sum }_{N \times M}^{ } {G}_{i} \times {weight}_{i} \qquad ( 10 )$$

AWB module 14 may then calculate the balance gain pair for the image based on the aggregated weights. For instance, AWB module 14 may calculate the balance gain pair for the image in accordance with Equations (11), below, where Gain_{R} is the red component of the balance gain pair and Gain_{B} is the blue component of the balance gain pair.

Gain_{R}=Gₛᵤₘ/Rₛᵤₘ

Gain_{B}=Gₛᵤₘ/Bₛᵤₘ (11)

In some examples, AWB module 14 may determine a balance gain pair for an entire image. In some examples, AWB module 14 may determine a balance gain pair based on the average of sub-blocks of the entire image (e.g., to enable a reduction in the computational complexity). For example, the entire image may be divided into

$$⌊ \frac{N}{{N}_{div}} ⌋ \times ⌊ \frac{M}{{M}_{div}} ⌋$$

blocks and AWB module 14 may perform the aggregation process with

$$⌊ \frac{N}{{N}_{div}} ⌋ \times ⌊ \frac{M}{{M}_{div}} ⌋$$

average RGB values, where N_{div} and M_{div} may be configurable scalers. For instance, AWB module 14 may be configured to calculate the balance gain pair by weighing average of N×M pixels. After dividing the entire image into blocks, AWB module 14 may calculate the weighting average of

$$⌊ \frac{N}{{N}_{div}} ⌋ \times ⌊ \frac{M}{{M}_{div}} ⌋$$

blocks.

AWB module 14 may determine other white balance parameters for the image using mesh-based interpolation based on the calculated balance gain pair. For instance, AWB module 14 may determine a color correction matrix (CCM), a color temperature (CT), and an adjust gain pair (AG) for point 70 of FIG. 3C, located in triangle 72. In some examples, point 70 of FIG. 3C may be a sample balance gain pair, such as a sample balance gain pair for an image determined in accordance with Equation (11), above. For instance, AWB module 14 may determine the CCM for point 70, in accordance with Equation (12), below, where CCM_{CW} is the CCM of sample point 32E, CCM_{TL84} is the CCM of sample point 32D, CCM_{A} is the CCM of sample point 32F, area_{A} is the area of a sub-triangle of triangle 72 having a vertex at point 70 and not having a vertex at sample point 32F, area_{CW} is the area of a sub-triangle of triangle 72 having a vertex at point 70 and not having a vertex at sample point 32E, and area_{TL84} is the area of a sub-triangle of triangle 72 having a vertex at point 70 and not having a vertex at sample point 32D.

$$CCM = \frac{{CCM}_{CW} \times {area}_{CW} + {CCM}_{TL 84} \times {area}_{TL 84} + {CCM}_{A} + {area}_{A}}{{area}_{CW} + {area}_{TL 84} + {area}_{A}} \qquad ( 12 )$$

AWB module 14 may determine the CT for point 70 of FIG. 3C in accordance with Equation (13), below, where CT_{CW} is the CT of sample point 32E, CT_{TL84} is the CT of sample point 32D, CT_{A} is the CT of sample point 32F.

$$CT = \frac{{CT}_{CW} \times {area}_{CW} + {CT}_{TL 84} \times {area}_{TL 84} + {CT}_{A} + {area}_{A}}{{area}_{CW} + {area}_{TL 84} + {area}_{A}} \qquad ( 13 )$$

AWB module 14 may determine the AG for point 70 of FIG. 3C in accordance with Equation (14), below, where AG_{CW} is the AG of sample point 32E, AG_{TL84} is the AG of sample point 32D, AG_{A} is the AG of sample point 32F.

$$AG = \frac{{AG}_{CW} \times {area}_{CW} + {AG}_{TL 84} \times {area}_{TL 84} + AG + {area}_{A}}{{area}_{CW} + {area}_{TL 84} + {area}_{A}} \qquad ( 14 )$$

AWB module 14 may determine a final balance gain pair for the image based on the determined adjust gain pair and the determined balance gain pair. For instance, AWB module 14 may determine the final balance gain pair (GainF_{R}′, GainF_{G}′, GainF_{B}′) in accordance with Equations (15), below, where Gain_{R} is the red component of the balance gain pair (e.g., Gain_{R} as determined in accordance with Equation (11)), Gain_{B} is the blue component of the balance gain pair (e.g., Gain_{B} as determined in accordance with Equation (11)), AG_{R} is the red component of the adjust gain pair (e.g., the red component of AG as determined in accordance with Equation (14)), and AG_{B} is the blue component of the adjust gain pair (e.g., the blue component of AG as determined in accordance with Equation (14)).

$${GainF}_{R} = {Gain}_{R} \times {AG}_{R} , \\ {GainF}_{B} = {Gain}_{B} \times {AG}_{B} , \\ {GainF}_{R}^{′} = \frac{{GainF}_{R}}{min ( {GainF}_{R} , {GainF}_{B} , 1.0 )} , \\ {GainF}_{B}^{′} = \frac{{GainF}_{B}}{min ( {GainF}_{R} , {GainF}_{B} , 1.0 )} , and \\ {GainF}_{G}^{′} = \frac{1.0}{min ( {GainF}_{R} , {GainF}_{B} , 1.0 )} \qquad ( 15 )$$

AWB module 14 may perform, based on the one or more white balance parameters, a white balance operation on the image data. For instance, AWB module 14 may modify the RGB values of pixels of image data based on the determined final balance gain pair. As the white balance parameters are calculated using a mesh-based interpolation, the AWB outputs may be smoothly transitioned when scenes change. Similarly, if the configuration of a point (i.e., a reference point or a gray zone boundary point) is hugely changed, the transition would still be stable. In this way, AWB module 14 may enable more accurate control of the white balancing process.

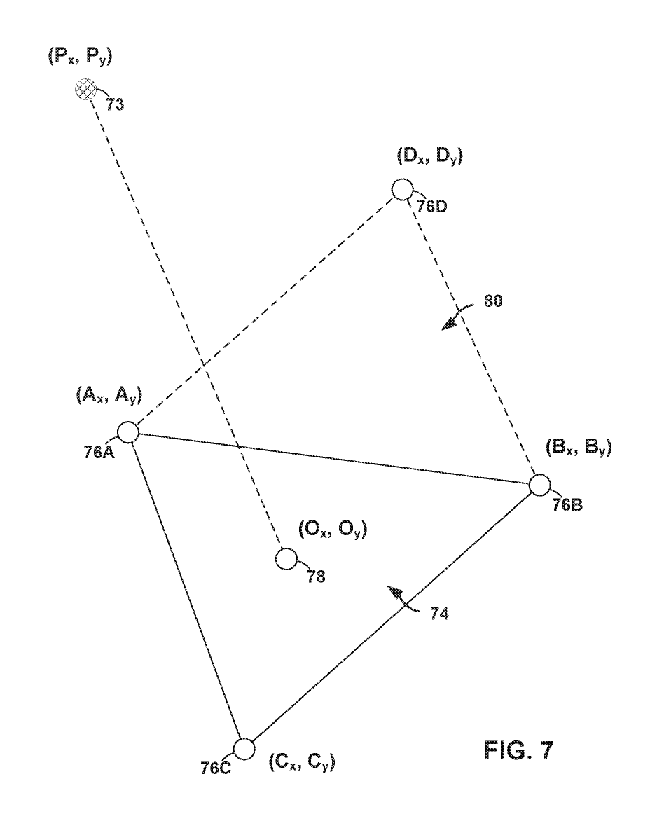

FIG. 7 is a conceptual diagram illustrating an example technique for identifying a triangle of a triangular matrix that includes a particular pixel of image data, in accordance with one or more techniques of this disclosure. As discussed above, AWB module 14 may identify a triangle of a triangular mesh that includes a pixel of the image data and determine one or more white balance parameters for the pixel of image data based on an interpolation of white balance parameters associated with vertices of the identified triangle. In some examples, it may be desirable for AWB module 14 to utilize a fast point location algorithm to efficiently find the triangle covering the given point. Additionally, in some cases, it may be desirable to build a specific data structure for the mesh in order to AWB module 14 to search efficiently.

In accordance with one or more techniques of this disclosure, in some examples, AWB module 14 may utilize point location by straight walking to identify a triangle of a triangular mesh that includes a pixel of the image data. To perform point location by straight walking, AWB module 14 may evaluate whether a particular point is within a first triangle of a plurality of triangles. If the particular point is not within the first triangle, AWB module 14 may select a next triangle of the plurality of triangles to evaluate based on which edge of the first triangle is crossed by a line between the particular point and a Barycentric point of the first triangle. For instance, AWB module 14 may select the next triangle to evaluate as the neighboring triangle of the first triangle that shares the edge of the first triangle is crossed by a line between the particular point and the Barycentric point of the first triangle. AWB module 14 may repeat this process until identifying a triangle of the plurality of triangles that includes the particular point.

As shown in the example of FIG. 7, AWB module 14 may utilize point location by straight walking to identify a triangle that includes point 73, which is located at (Pₓ, P_{y}). AWB module 14 may determine whether point 73 is included within triangle 74, which has vertices 76A, 76B, and 76C. As point 73 is not included within triangle 74, AWB module 14 may determine which edge of triangle 74 is crossed by a line that connects point 73 with Barycentric point 78 of triangle 74. In some examples, AWB module 14 may determine Barycentric point 78 in accordance with Equation (16), below, where Aₓ, A_{y} are the coordinates of point 76A, Bₓ, B_{y} are the coordinates of point 76B, Cₓ, C_{y} are the coordinates of point 76A, and Qₓ, Q_{y} are the coordinates of Barycentric point 78.

$${Q}_{x} = \frac{( {A}_{x} + {B}_{x} + {C}_{x} )}{3} , and \\ {Q}_{y} = \frac{( {A}_{y} + {B}_{y} + {C}_{y} )}{3} \qquad ( 16 )$$

In the example of FIG. 7, the line that connects point 73 with Barycentric point 78 of triangle 74 crosses edge A̅B̅ (i.e., the edge connecting points 76A and 76B). As such, AWB module 14 may next evaluate neighboring triangle 80, which has vertices 76A, 76B, and 76D. As discussed above, AWB module 14 may repeat this process until identifying a triangle of the plurality of triangles that includes point 73.

In some examples, AWB module 14 may identify a triangle of a plurality of triangles that includes a particular point in accordance with the following pseudo code.

algorithm point_location is

| input: | triangulation trid, |
|---|---|
| | triangle number trid_num, |
| | query point p |
| output: | triangle index i covering query point p |

i ← 0
while i in trid_num do

if trid(i) covers p

return i

else

```
  let o be the barycentric of trid(i)
  let e1, e2, e3 be the edges of trid(i)
  let t1, t2, t3 be the neighboring triangle
```

indexes

sharing edge e1, e2, e3

if e1 crosses edge po

i ← t1

else if e2 crosses edge po

i ← t2

else

i ← t3

As discussed above, as the white balance parameters are calculated using a mesh-based interpolation, the AWB outputs may be smoothly transitioned when scenes change and, if the configuration of a point (i.e., a reference point or a gray zone boundary point) is hugely changed, the transition would still be stable. Additionally, in accordance with one or more techniques of this disclosure, AWB module 14 may enable the insertion of additional points into the mesh (i.e., to control of non-uniform distribution of AWB outputs in a given color space). For instance, a specific scene could be estimated and presented as a balance gain pair point. The balance gain pair point may be associated with values for white balance parameters. For example, the balance gain pair point may be associated with a CCM, CT, and AG. In some examples, the new points may be referred to as user-defined points.

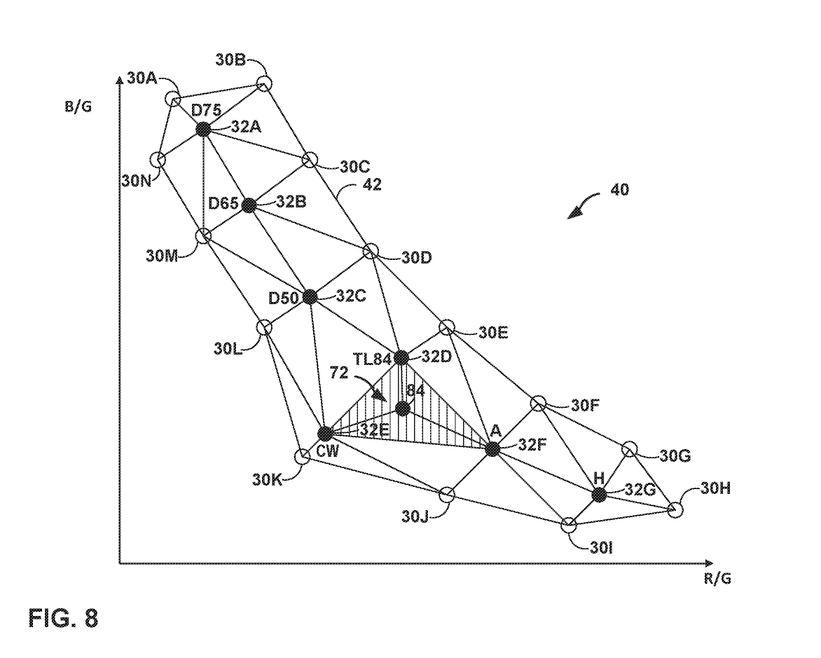

Once the new point is added, a new triangulation process may be performed. For instance, as shown in FIG. 8, a triangulation process resulting from the addition of new point 84 may result in triangle 72 being divided into three separate triangles, each having a vertex at new point 84.

Adding a point into the mesh could directly and intuitively control its CCM, CT, and AG (i.e., making it easier to tune a specific scene). Tuning a specific scene does not lead to large-scope AWB changes, since the impact would be limited in small-scope mesh. If a new point 84 is added (i.e., between points 32E, 32D, and 32F), the balance gains and CCM would not be impacted under 32C, 32B, 32A, or 32G. In some examples, unlimited scenes presented as points could be added to the mesh. As more points are added to the mesh, AWB may become more accurate AWB. As such, the AWB system may be configured such that what you see is what you set. After triangulation and Barycentric interpolation, AWB module 14 would still output smoothly transitive factors. In this way, AWB module 14 may provide flexibility for the tuning of AWB settings.

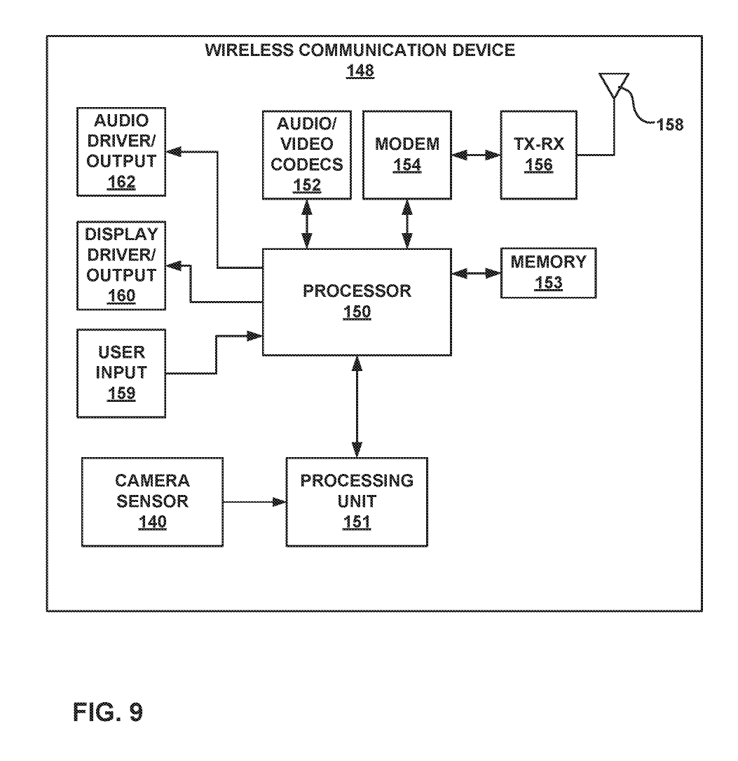

FIG. 9 is an exemplary block diagram illustrating a wireless communication device 148 capable of implementing the techniques of this disclosure. As mentioned above, camera sensors may be provided within wireless communication devices such as a mobile radiotelephone to form a so-called camera phone or video phone. In this aspect of the disclosure, as shown in FIG. 9, wireless communication device 148 may include various components of digital camera device 2 (FIG. 1), as well as various components to support wireless communication and user interface features. For example, wireless communication device 148 may include a processor 150, audio/video encoders/decoders (CODECs) 152, a memory 153, a modem 154, a transmit-receive (TX/RX) unit 156, a radio frequency (RF) antenna 158, a user input device 159, a display driver/output device 160, an audio driver/output device 162, a camera sensor 140 and a processing unit 151. Processor 150 may be used to execute the calibration techniques described herein.

Camera sensor 140 captures information and sends the captured information to processing unit 151. Processing unit 151 may perform various image processing functions, including application of gray point correction factors Fx and Fy. Processor 150 performs the calibration techniques described herein in order to generate the correction factors Fx and Fy. In this sense, processor 150 may execute the techniques performed by AWB module 14 of digital camera device 2 of FIG. 1.

In addition, however, processor 150 may also control a display driver and associated display output 160 and an audio driver and associated audio output 162 to present images, video and associated sounds to the user via a display and speaker associated with the wireless communication device 148. The presentation of images on display output 160 may be improved by the calibration techniques described herein. Memory 157 may store instructions for execution by processor 150 to support various operations. Although not shown in FIG. 9, memory 157 (or another memory) may be coupled to processing unit 151 or other components to store data that is processed or generated by such components. User input device 159 may include any of a variety of input media such as keys, buttons, touchscreen media or the like for the user to control operation of wireless communication device 148.

The images and audio and imagery or video may be encoded by audio/video CODECs 152 for storage and transmission. In the example of FIG. 9, audio/video CODECs may reside with the larger wireless communication device 148 to handle a variety of audio and video applications, in addition to video that may be captured by camera sensor 140. Audio-video CODECs may encode images or video according to any of a variety of encoding techniques or formats, such as MPEG-2, MPEG-4, ITU H.263, ITU H.264, ITU H.265, JPEG, or the like.

In addition, in some aspects, wireless communication device 148 may encode and transmit such audio, images or video to other devices by wireless communication, as well as receive audio, images or video from other devices and encode it. For example, modem 154 and transmit-receive (TX-RX) unit 156 may be used to transmit encoded audio and image or video information to other wireless communication devices via 158. Modem 154 may modulate the encoded information for transmission over the air interface provided by TX-RX unit 156 and antenna 158. In addition, TX-RX unit 156 and modem 154 may process signals received via antenna 158, including encoded audio, imagery or video. TX-RX unit 156 may further include suitable mixer, filter, and amplifier circuitry to support wireless transmission and reception via antenna 158.

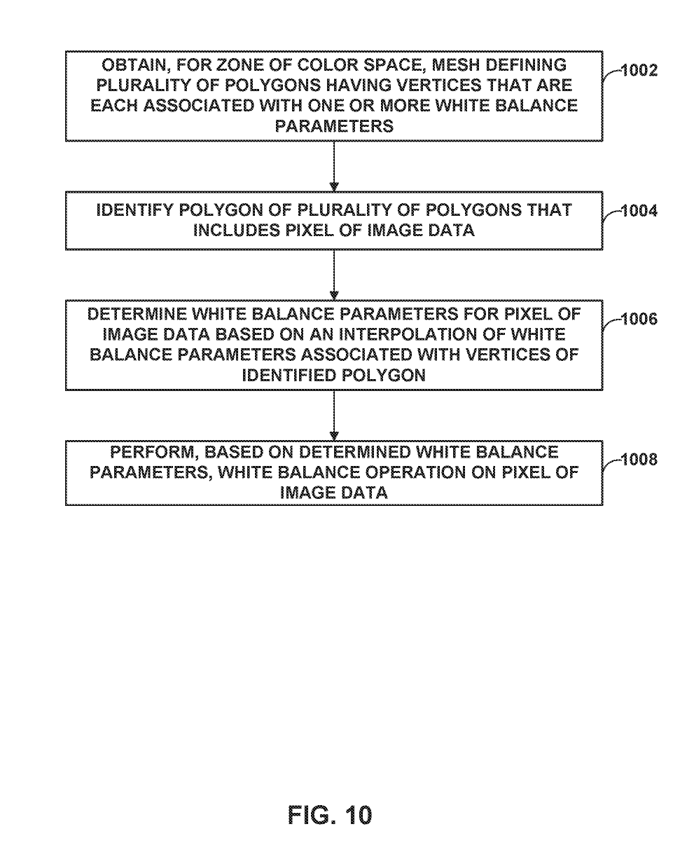

FIG. 10 is a flow diagram illustrating example auto white balance operations using a triangular mesh, in accordance with one or more techniques of the present disclosure. The techniques of FIG. 10 may be performed by one or more devices, such as digital camera device 2 of FIG. 1 and/or wireless communication device 148 of FIG. 9. For purposes of illustration, the techniques of FIG. 10 are described within the context of digital camera device 2, although devices having configurations different than that of digital camera device 2 may perform the techniques of FIG. 10.

Digital camera device 2 may obtain, for a zone of a color space, a mesh defining a plurality of polygons having vertices that are each associated with one or more white balance parameters (1002). In some examples, the zone of the color space may be a gray zone of the color space. In some examples, the vertices of the mesh may include reference points within the zone, such as reference points 32 of FIG. 3A, and boundary points of the zone, such as gay zone boundary points 30 of FIG. 3A. As discussed above, each of reference points 32 and zone boundary points 30 may be associated with one or more pre-determined white balance parameters, such as a pre-determined AW, CCM, CT, and AG. Examples of polygons that may be defined by the mesh include, but are not necessarily limited to, triangles, quadrilaterals, pentagons, hexagons, heptagons, etc.

Digital camera device 2 may identify a polygon of the plurality of polygons that includes a pixel of image data within the color space (1004). For instance, where the plurality of polygons includes a plurality of triangles, digital camera device 2 may identify a triangle of the plurality of triangles that includes a pixel of image data using point location by straight walking as discussed above with reference to FIG. 7.

Digital camera device 2 may determine one or more white balance parameters for the pixel of the image data based on an interpolation of white balance parameters associated with vertices of the polygon that includes the pixel (1006). For instance, digital camera device 2 may determine an AW for a pixel of image data using a Barycentric interpolation of white balance parameters associated with vertices of the polygon that includes the pixel as discussed above with reference to FIG. 3B. Digital camera device 2 may aggregate the AWs for the image, or a portion therefore, and determine a balance gain pair. For instance, digital camera device 2 may determine a balance gain pair in accordance with Equation (11), above.

Digital camera device 2 may identify a triangle that include the determined balance gain pair and determine one or more other white balance parameters for the determined balance gain pair based on an interpolation of white balance parameters associated with vertices of the triangle that includes the balance gain pair. For instance, digital camera device 2 may determine a CCM, CT, and AG for the balance gain pair in accordance with Equations (12)-(14), above.

Digital camera device 2 may determine a final balance gain pair for the image based on the determined adjust gain pair and the determined balance gain pair. For instance, digital camera device 2 may determine the final balance gain pair in accordance with Equations (15), above.

Digital camera device 2 may perform, based on the one or more white balance parameters determined for the pixel of the image data, a white balance operation on the pixel of the image data (1008). For instance, digital camera device 2 may modify the RGB values of pixels of the image data based on the determined final balance gain pair.

In this way, digital camera device 2 may utilize multiple and extendable reference points for different illuminance, triangulation constructed mesh with automatic boundary point generation, fast search for a query point, and/or triangular Barycentric interpolation. Using these techniques, digital camera device 2 may extend reference points to unlimited scenes under different color temperatures and all factors contained in the reference point can be transited smoothly. The final results of the white balance system could be controlled intuitively and accurately.

The following numbered examples may illustrate one or more aspects of the disclosure:

### EXAMPLE 1

A method for white balancing image data, the method comprising: obtaining, for a zone of a color space, a mesh defining a plurality of polygons having vertices that are each associated with one or more white balance parameters; identifying a polygon of the plurality of polygons that includes a pixel of the image data; determining one or more white balance parameters for the pixel of the image data based on an interpolation of white balance parameters associated with vertices of the polygon that includes the pixel of the image data; and performing, based on the one or more white balance parameters for the pixel of the image data, a white balance operation on the pixel of the image data.

### EXAMPLE 2

The method of example 1, wherein the plurality of polygons comprise a plurality of triangles, wherein identifying the polygon of the plurality of polygons that includes the pixel of the images data comprises identifying a triangle of the plurality of triangles that includes the pixel of image data, and wherein determining the one or more white balance parameters for the pixel of the image data comprises determining one or more white balance parameters for the pixel of the image data based on an interpolation of white balance parameters associated with vertices of the triangle that includes the pixel of the image data.

### EXAMPLE 3

The method of any combination of examples 1-2, wherein the zone of the color space comprises a gray zone of the color space, and wherein the vertices of the mesh include reference points within the gray zone and boundary points of the gray zone.

### EXAMPLE 4

The method of any combination of examples 1-3, wherein the boundary points of the gray zone are determined based on the reference points within the gray zone and gray zone distances.

### EXAMPLE 5

The method of any combination of examples 1-4, wherein the reference points comprise pre-defined reference points that correspond to different lighting conditions.

### EXAMPLE 6

The method of any combination of examples 1-5, wherein the reference points further comprise one or more user-defined reference points.

### EXAMPLE 7

The method of any combination of examples 1-6, wherein determining the one or more white balance parameters for the pixel of the image data comprises: determining a Barycentric interpolation of the white balance parameters associated with vertices of the polygon that includes the pixel of the image data.

### EXAMPLE 8

The method of any combination of examples 1-7, wherein determining one or more white balance parameters for the pixel of the image data comprises: determining respective aggregation weights for pixels of the image data; determining, based on the determined aggregation weights, a balance gain pair for the image data; identifying a polygon of the plurality of polygons that includes the determined balance gain pair; determining, based on an interpolation of aggregation weights associated with vertices of the polygon that includes the determined balance gain pair, an adjust gain pair; and determining, based on the adjust gain pair and the determined balance gain pair, a final balance gain pair for the image data, wherein performing the white balance operation on the pixel of the image data comprises: performing, based on the determined final balance gain pair, a white balance operation on the pixel of the image data.

### EXAMPLE 9

The method of any combination of examples 1-8, wherein the one or more white balance parameters include one or more of: an aggregation weight, a color correction matrix, a color temperature, and an adjust gain pair.

### EXAMPLE 10

The method of any combination of examples 1-9, the method being executable on a wireless communication device, wherein the device comprises: a camera configured to capture the image data; a memory configured to store the image data; and one or more processors configured to execute instructions to process the image data stored in said memory.

### EXAMPLE 11

A device for white balancing image data, the device comprising: a memory configured to store the image data; and one or more processors configured to perform the method of any combination of examples 1-9.

### EXAMPLE 12

The device of example 11, further comprising one or more of: a camera configured to capture the image data; and a display configured to display the white balanced image data.

### EXAMPLE 13

A device for white balancing image data, the device comprising means for performing the method of any combination of examples 1-9.

### EXAMPLE 14

The device of example 13, further comprising one or more of: means for capturing capture the image data; and means for displaying the white balanced image data.

### EXAMPLE 15

A non-transitory computer-readable storage medium storing instructions that, when executed, cause a device for white balancing image data to perform the method of any combination of examples 1-9.

The techniques described herein may be implemented in hardware, software, firmware or any combination thereof. Any of the described units, modules or components may be implemented together in an integrated logic device or separately as discrete but interoperable logic devices. In some cases, various features may be implemented as an integrated circuit device, such as an integrated circuit chip or chipset. If implemented in software, the techniques may be realized at least in part by a computer-readable medium comprising instructions that, when executed, performs one or more of the techniques described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates instructions or data structures and that can be accessed, read, and/or executed by a computer.

The instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules, hardware modules, or any combination thereof.

If implemented in hardware or a combination of hardware and software, the techniques described herein may be embodied in an apparatus, device or integrated circuit, which may comprise AWB module 14 shown in FIG. 1, or possibly a combination of components shown in FIG. 1. An integrated circuit, for example, can be configured to perform one or more of the techniques described herein. These and other examples are within the scope of the following claims.

1. A method for white balancing image data, the method comprising:
obtaining, for a zone of a color space, a mesh defining a plurality of polygons having vertices that are each associated with one or more white balance parameters;
identifying a polygon of the plurality of polygons that includes a pixel of the image data;
determining one or more white balance parameters for the pixel of the image data based on an interpolation of white balance parameters associated with vertices of the polygon that includes the pixel of the image data; and
performing, based on the one or more white balance parameters for the pixel of the image data, a white balance operation on the pixel of the image data.

2. The method of claim 1, wherein the plurality of polygons comprise a plurality of triangles, wherein identifying the polygon of the plurality of polygons that includes the pixel of the images data comprises identifying a triangle of the plurality of triangles that includes the pixel of image data, and wherein determining the one or more white balance parameters for the pixel of the image data comprises determining one or more white balance parameters for the pixel of the image data based on an interpolation of white balance parameters associated with vertices of the triangle that includes the pixel of the image data.

3. The method of claim 1, wherein the zone of the color space comprises a gray zone of the color space, and wherein the vertices of the mesh include reference points within the gray zone and boundary points of the gray zone.

4. The method of claim 3, wherein the boundary points of the gray zone are determined based on the reference points within the gray zone and gray zone distances.

5. The method of claim 3, wherein the reference points comprise pre-defined reference points that correspond to different lighting conditions.

6. The method of claim 3, wherein the reference points further comprise one or more user-defined reference points.

7. The method of claim 1, wherein determining the one or more white balance parameters for the pixel of the image data comprises:
determining a Barycentric interpolation of the white balance parameters associated with vertices of the polygon that includes the pixel of the image data.

8. The method of claim 1, wherein determining one or more white balance parameters for the pixel of the image data comprises:
determining respective aggregation weights for a plurality of pixels of the image data;
determining, based on the determined aggregation weights, a balance gain pair for the image data;
identifying a polygon of the plurality of polygons that includes the determined balance gain pair;
determining, based on an interpolation of aggregation weights associated with vertices of the polygon that includes the determined balance gain pair, an adjust gain pair; and
determining, based on the adjust gain pair and the determined balance gain pair, a final balance gain pair for the image data, wherein performing the white balance operation on the pixel of the image data comprises:
performing, based on the determined final balance gain pair, a white balance operation on the pixel of the image data.

9. The method of claim 1, wherein the one or more white balance parameters include one or more of: an aggregation weight, a color correction matrix, a color temperature, and an adjust gain pair.

10. The method of claim 1, the method being executable on a wireless communication device, wherein the device comprises:
a camera configured to capture the image data;
a memory configured to store the image data; and
one or more processors configured to execute instructions to process the image data stored in said memory.

11. A device for white balancing image data, the device comprising:
a memory configured to store the image data; and
one or more processors configured to:
obtain, for a zone of a color space, a mesh defining a plurality of polygons having vertices that are each associated with one or more white balance parameters;
identify a polygon of the plurality of polygons that includes a pixel of the image data;
determine one or more white balance parameters for the pixel of the image data based on an interpolation of white balance parameters associated with vertices of the polygon that includes the pixel of the image data; and
perform, based on the one or more white balance parameters for the pixel of the image data, a white balance operation on the pixel of the image data.

12. The device of claim 11, wherein:
the plurality of polygons comprise a plurality of triangles,
to identify the polygon of the plurality of polygons that includes the pixel of the images data, the one or more processors are configured to identify a triangle of the plurality of triangles that includes the pixel of image data, and
to determine the one or more white balance parameters for the pixel of the image data, the one or more processors are configured to determine one or more white balance parameters for the pixel of the image data based on an interpolation of white balance parameters associated with vertices of the triangle that includes the pixel of the image data.

13. The device of claim 11, wherein the zone of the color space comprises a gray zone of the color space, and wherein the vertices of the mesh include reference points within the gray zone and boundary points of the gray zone.

14. The device of claim 13, wherein the boundary points of the gray zone are determined based on the reference points within the gray zone and gray zone distances.

15. The device of claim 13, wherein the reference points comprise pre-defined reference points that correspond to different lighting conditions.

16. The device of claim 13, wherein the reference points further comprise one or more user-defined reference points.

17. The device of claim 11, wherein, to determine the one or more white balance parameters for the pixel of the image data, the one or more processors are configured to:
determine a Barycentric interpolation of the white balance parameters associated with vertices of the polygon that includes the pixel of the image data.

18. The device of claim 11, wherein, to determine one or more white balance parameters for the pixel of the image data, the one or more processors are configured to:
determine respective aggregation weights for a plurality of pixels of the image data;
determine, based on the determined aggregation weights, a balance gain pair for the image data;
identify a polygon of the plurality of polygons that includes the determined balance gain pair;
determine, based on an interpolation of aggregation weights associated with vertices of the polygon that includes the determined balance gain pair, an adjust gain pair; and
determine, based on the adjust gain pair and the determined balance gain pair, a final balance gain pair for the image data, wherein, to perform the white balance operation on the pixel of the image data, the one or more processors are configured to:
perform, based on the determined final balance gain pair, a white balance operation on the plurality of pixels of the image data.

19. The method of claim 11, wherein the one or more white balance parameters include one or more of: an aggregation weight, a color correction matrix, a color temperature, and an adjust gain pair.

20. The device of claim 11, further comprising:
a camera configured to capture the image data.

21. A device for white balancing image data, the device comprising:
means for obtaining, for a zone of a color space, a mesh defining a plurality of polygons having vertices that are each associated with one or more white balance parameters;
means for identifying a polygon of the plurality of polygons that includes a pixel of the image data;
means for determining one or more white balance parameters for the pixel of the image data based on an interpolation of white balance parameters associated with vertices of the polygon that includes the pixel of the image data; and
means for performing, based on the one or more white balance parameters for the pixel of the image data, a white balance operation on the pixel of the image data.

22. The device of claim 21, wherein the plurality of polygons comprise a plurality of triangles, wherein the means for identifying the polygon of the plurality of polygons that includes the pixel of the images data comprise means for identifying a triangle of the plurality of triangles that includes the pixel of image data, and wherein the means for determining the one or more white balance parameters for the pixel of the image data comprise means for determining one or more white balance parameters for the pixel of the image data based on an interpolation of white balance parameters associated with vertices of the triangle that includes the pixel of the image data.

23. The device of claim 21, wherein the zone of the color space comprises a gray zone of the color space, and wherein the vertices of the mesh include reference points within the gray zone and boundary points of the gray zone.

24. The device of claim 23, wherein the boundary points of the gray zone are determined based on the reference points within the gray zone and gray zone distances.

25. The device of claim 23, wherein the reference points comprise pre-defined reference points that correspond to different lighting conditions.

26. The device of claim 23, wherein the reference points further comprise one or more user-defined reference points.

27. The device of claim 21, wherein the means for determining the one or more white balance parameters for the pixel of the image data comprise:
means for determining a Barycentric interpolation of the white balance parameters associated with vertices of the polygon that includes the pixel of the image data.

28. The method of claim 21, wherein the means for determining one or more white balance parameters for the pixel of the image data comprise:
means for determining respective aggregation weights for pixels of the image data;
means for determining, based on the determined aggregation weights, a balance gain pair for the image data;
means for identifying a polygon of the plurality of polygons that includes the determined balance gain pair;
means for determining, based on an interpolation of aggregation weights associated with vertices of the polygon that includes the determined balance gain pair, an adjust gain pair; and
means for determining, based on the adjust gain pair and the determined balance gain pair, a final balance gain pair for the image data, wherein the means for performing the white balance operation on the pixel of the image data comprise:
means for performing, based on the determined final balance gain pair, a white balance operation on the pixel of the image data.

29. A non-transitory computer-readable storage medium storing instructions that, when executed, cause a device for white balancing image data to:
obtain, for a zone of a color space, a mesh defining a plurality of polygons having vertices that are each associated with one or more white balance parameters;
identify a polygon of the plurality of polygons that includes a pixel of the image data;
determine one or more white balance parameters for the pixel of the image data based on an interpolation of white balance parameters associated with vertices of the polygon that includes the pixel of the image data; and
perform, based on the one or more white balance parameters for the pixel of the image data, a white balance operation on the pixel of the image data.

30. The non-transitory computer-readable storage medium of claim 29, wherein the plurality of polygons comprise a plurality of triangles, wherein the instructions the cause the one or more processors to identify the polygon of the plurality of polygons that includes the pixel of the images data comprises instructions that cause the one or more processors to identify a triangle of the plurality of triangles that includes the pixel of image data, and wherein the instructions that cause the one or more processors to determine the one or more white balance parameters for the pixel of the image data comprise instructions that cause the one or more processors to:
determine, based on an interpolation of white balance parameters associated with vertices of the triangle that includes the pixel of the image data, respective aggregation weights for pixels of the image data;
determine, based on the determined aggregation weights, a balance gain pair for the image data;
identify a triangle of the plurality of triangles that includes the determined balance gain pair;
determine, based on an interpolation of aggregation weights associated with vertices of the triangle that includes the determined balance gain pair, an adjust gain pair; and
determine, based on the adjust gain pair and the determined balance gain pair, a final balance gain pair for the image data, wherein the instructions that cause the one or more processors to perform the white balance operation on the pixel of the image data comprise instructions that cause the one or more processors to:
perform, based on the determined final balance gain pair, a white balance operation on the pixel of the image data
